(19) United States
(12) Patent Application Publication
(10) Pub. No.: US 2010/0124433 A1
(43) Pub. Date: May 20, 2010

(54) Developer, developer storing body, developing device and image forming apparatus

(75) Inventor: Yuki Matsuura, Tokyo (JP)

Correspondence Address: RABIN & Berdo, PC, 1101 14TH STREET, NW, SUITE 500, WASHINGTON, DC, 20005, US

(73) Assignee: OKI DATA CORPORATION, Tokyo (JP)

(21) Appl. No.: 12/591,035

(22) Filed: Nov. 5, 2009

(30) Foreign Application Priority Data
Nov. 14, 2008 (JP) 2008-291703

(51) Int. Cl. G03G 21/16; G03G 9/08; G03G 15/08

(52) U.S. Cl. 399/119; 430/110.1; 430/108.7; 430/110.3; 399/252

(57) ABSTRACT

A developer includes a toner containing toner mother particles and external additives added to the toner mother particles. The toner mother particles contain at least a resin and a coloring agent. 1.5 to 3.0 weight parts of the external additives are added to 100 weight parts of the toner mother particles. The toner has a mean volume diameter in a range from 6.5 to 8.0 μm, and a surface roughness Rzjis in a range from 75.3 to 236.9 nm as measured using a scanning probe microscope.

### BACKGROUND OF THE INVENTION

The present invention relates to a developer, a developer storing body, a developing device and an image forming apparatus such as a copier, a facsimile, a printer or the like.

Generally, an electrophotographic image forming process includes a charging process for uniformly charging a photoconductive insulation layer of an image bearing body, and an exposing process for exposing the photoconductive insulation layer to cause electric charge on the exposed parts to vanish so as to form a latent image. The image forming process further includes a developing process for developing the latent image with a toner (i.e., a developer) containing at least a resin and a coloring agent so as to form a toner image (i.e., a visualized image), a transferring process for transferring the toner image to a recording medium (for example, a paper), and a fixing process for fixing the toner image to the recording medium by applying heat and pressure or using other kinds fixing method.

The toner used in the electrophotographic image forming process is manufactured by adding external additives to toner mother particles generally containing a pigment, a resin, a wax, a charge controlling agent or the like. In order to enhance image quality, there has been proposed a technique of changing the kind and amount of the external additives added to the toner mother particles (see, for example, Japanese Laid-Open Patent Publication No. 2007-139846).

However, in the case where an image forming apparatus using the above described toner restarts the image forming process after a long period of non-use (i.e., a period while the image forming apparatus does not perform the image forming process), image quality may be degraded.

### SUMMARY OF THE INVENTION

The present invention is intended to prevent degradation of image quality.

The present invention provides a developer including a toner containing toner mother particles and external additives added to the toner mother particles. The toner mother particles contain at least a resin and a coloring agent. 1.5 to 3.0 weight parts of the external additives are added to 100 weight parts of the toner mother particles. The toner has a mean volume diameter in a range from 6.5 to 8.0 μm, and a surface roughness Rzjis in a range from 75.3 to 236.9 nm as measured using a scanning probe microscope.

With such a configuration, it becomes possible to prevent the occurrence of the fog or the like even when an image forming process is restarted after a long period of non-use.

The present invention also provides a developer storing body including a developer storing portion storing a developer. The developer includes a toner containing toner mother particles and external additives added to the toner mother particles. The toner mother particles contain at least a resin and a coloring agent. 1.5 to 3.0 weight parts of the external additives are added to 100 weight parts of the toner mother particles. The toner has a mean volume diameter in a range from 6.5 to 8.0 μm, and a surface roughness Rzjis in a range from 75.3 to 236.9 nm as measured using a scanning probe microscope.

The present invention also provides a developing device including a developer storing body that stores a developer, a developer bearing body that bears the developer supplied from the developer storing body, and an image bearing body to which the developer is supplied by the developer bearing body. The developer includes a toner containing toner mother particles and external additives added to the toner mother particles. The toner mother particles contain at least a resin and a coloring agent. 1.5 to 3.0 weight parts of the external additives are added to 100 weight parts of the toner mother particles. The toner has a mean volume diameter in a range from 6.5 to 8.0 μm, and a surface roughness Rzjis in a range from 75.3 to 236.9 nm as measured using a scanning probe microscope.

The present invention also provides an image forming apparatus including a developing device that stores a developer, and forms a developer image using the developer, a transferring unit that transfers the developer image formed by the developing device to a recording medium, and a fixing unit that fixes the developer image to the recording medium. The developer includes a toner containing toner mother particles and external additives added to the toner mother particles. The toner mother particles contain at least a resin and a coloring agent. 1.5 to 3.0 weight parts of the external additives are added to 100 weight parts of the toner mother particles. The toner has a mean volume diameter in a range from 6.5 to 8.0 μm, and a surface roughness Rzjis in a range from 75.3 to 236.9 nm as measured using a scanning probe microscope.

Further scope of applicability of the present invention will become apparent from the detailed description given hereinafter. However, it should be understood that the detailed description and specific embodiments, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

In the attached drawings:

FIG. 1 is a schematic view showing a printer according to the first embodiment of the present invention;

FIG. 2 is a schematic view showing a developing device according to the first embodiment of the present invention;

FIG. 3 is a schematic view showing a toner cartridge according to the first embodiment of the present invention;

FIGS. 4A, 4B and 4C show conditions and results of a test according to the first embodiment of the present invention;

FIG. 5 is a graph showing a relationship between a mean particle diameter and a surface roughness Rzjis of a toner;

FIG. 6 is a graph showing a relationship between an adding amount of external additives and the surface roughness Rzjis of the toner;

FIG. 7A is schematic view showing a sponge roller, a developing roller and a toner according to the second embodiment to the present invention;

FIG. 7B is a perspective view showing the sponge roller according to the second embodiment of the present invention, and

FIGS. 8A and 8B show conditions and results of a test according to the second embodiment of the present invention.

### DETAILED DESCRIPTION OF THE PREFERRED EMBODIMENT

Hereinafter, embodiments of the present invention will be described with reference to the attached drawings. The present invention is not limited to the embodiments, but modifications and improvements may be made to the invention without departing from the spirit and scope of the invention.

### First Embodiment

First, a description will be made of a printer as an image forming apparatus that forms an image using a toner as a developer according to the first embodiment of the present invention. Next, descriptions will be made of a developing device that develops a latent image on a latent image bearing body using the toner, and a developer cartridge (i.e., a developer storing body) that stores the toner. Subsequently, a description will be made of the toner itself.

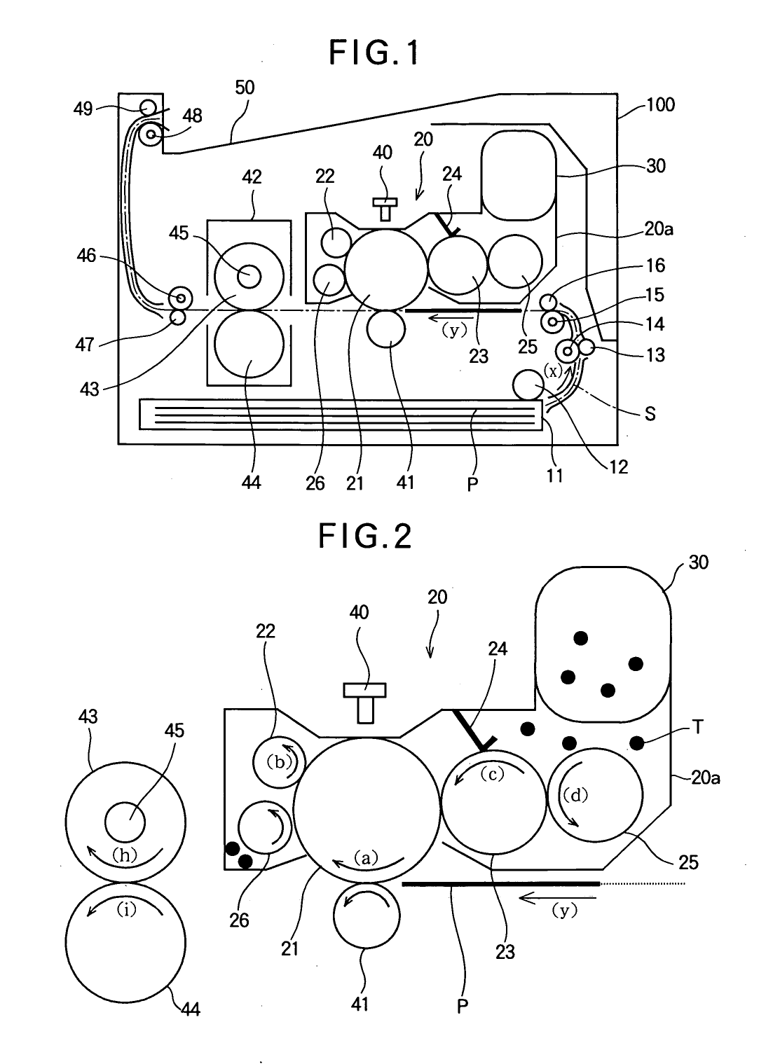

In FIG. 1, a printer 100 as an image forming apparatus is configured to form an image on a sheet (i.e., a recording medium) P using the above described electrophotographic method. The printer 100 includes a substantially S-shaped sheet feeding path that leads from a sheet cassette 11 to a pair of ejection rollers 48 and 49. The printer 100 includes a developing device 20 and a fixing unit 42 disposed along the sheet feeding path. The printer 100 further includes feeding rollers or the like that feed the sheet P passing through the developing device 20 and the feeding unit 42.

The sheet cassette 11 is detachably mounted to a lower part of the printer 100, and stores a stack of the sheets P. A hopping roller 12 is disposed on an upper side of the sheet cassette 11. The hopping roller 12 is configured to individually feed the sheet P out of the sheet cassette 11 in a direction shown by an arrow (x).

A feeding roller 13 and a pinch roller 14 are disposed facing each other on a downstream side of the hopping roller 12. The feeding roller 13 and the pinch roller 14 sandwich the sheet P (fed out of the sheet cassette 11 by the hopping roller 12) therebetween, and feed the sheet P. A registration roller 15 and a pinch roller 16 are disposed facing each other on a downstream side of the feeding roller 13 and the pinch roller 14. The registration roller 15 and the pinch roller 16 sandwich the sheet P therebetween, and feed the sheet P to the developing device 20 while correcting a skew of the sheet P. These rollers 13, 14, 15 and 16 are rotated by power transmitted from not shown driving motors via gears or the like.

The developing device 20 is detachably mounted to the printer 100, and is disposed along the sheet feeding path S in the printer 100. An LED (Light Emitting Diode) head 40 as an exposing unit is disposed in the printer 100, and is configured to expose a surface of a photosensitive drum 21 as an image bearing body. The developing device 20 develops the latent image on the photosensitive drum 21 using a toner. The developing device 20 will be described later in detail.

A toner cartridge 30 (i.e., a developer storing body or a developer cartridge) is detachably mounted to a main body 20a of the developing device 20 at a predetermined position. The toner cartridge 30 includes a storing portion 32 that stores a toner (for example, a black toner). The toner cartridge 30 will be described later in detail.

The LED head 40 includes, for example, an LED element and a lens array. The LED head 40 is disposed so that lights emitted by the LED element are focused on the surface of the photosensitive drum 21.

A transfer roller 41 is disposed facing the surface of the photosensitive drum 21, and is pressed against the surface of the photosensitive drum 21. The transfer roller 41 is formed of a conductive rubber or the like. The transfer roller 41 is applied with a bias voltage by a not shown high-voltage power source (provided for the transfer roller 41), and transfers the toner image (i.e., a developed image) on the photosensitive drum 21 to the sheet P.

The fixing unit 42 is disposed on the downstream side of the developing device 20 along the sheet feeding path S, and includes a heat roller 43, a backup roller 44 and a not shown thermistor. The heat roller 43 is composed of, for example, a metal core in the form of a hollow cylinder made of aluminum or the like, a heat-resisting resilient layer made of silicone rubber covering the metal core, and a PFA (tetra fluoro ethylene perfluoro alkyl vinyl ether copolymer) tube covering the resilient layer. A heater 45 such as a halogen lamp is disposed inside the metal core. The backup roller 44 is composed of, for example, a metal core made of aluminum or the like, a heat-resisting resilient layer made of silicone rubber covering the metal core, and a PFA (tetra fluoro ethylene perfluoro alkyl vinyl ether copolymer) tube covering the resilient layer. The heat roller 43 and the backup roller 44 form a nip portion therebetween. The thermistor (not shown) as a surface-temperature detecting unit is disposed in the vicinity of the heat roller 43 in non-contact manner. The heater 45 is controlled based on the surface temperature detected by the thermistor, so that the surface temperature of the heat roller 43 is maintained at a predetermined temperature. The sheet P with the toner image having been transferred passes through a nip portion between the heat roller 43 (maintained at a predetermined temperature) and the backup roller 44, and is applied with heat and pressure. With the heat and pressure, the toner on the sheet P is molten, and is fixed to the sheet P.

A feeding roller 46 and a pinch roller 47 are disposed facing each other on the downstream side of the fixing unit 42. The feeding roller 46 and the pinch roller 47 sandwich the sheet P therebetween, and feed the sheet P. An ejection roller 48 and a pinch roller 49 are disposed facing each other on the downstream side of the feeding roller 46 and the pinch roller 47. The ejection roller 48 and the pinch roller 49 sandwich the sheet P therebetween, and eject the sheet P to a sheet stacker 50. The sheet stacker 50 is provided on an outer side of a casing of the printer 100. The sheets P ejected out of the printer 100 by the ejection roller 48 and the pinch roller 49 are stacked on the sheet stacker 50.

Although not shown in FIG. 1, the printer 100 includes a print-control unit, an interface-control unit, a receiving memory and an image data editing memory. The print-control unit includes a micro processer, a ROM (Read Only Memory), a RAM (Random Access Memory), an input/output port, a timer or the like. The interface-control unit is configured to receive print data and control command and to control entire sequences of the printer 100 to perform a printing operation. The receiving memory is configured to temporarily store print data inputted via the interface-control unit. The image data editing memory is configured to receive the print data stored in the receiving memory, to edit the print data to thereby obtain image data, and to store the image data. The printer 100 further includes a display unit having a display such as LCD (Liquid Crystal Display), an operation unit with an input unit such as a touch panel operated by a user, and various kinds of sensors for monitoring a condition of the printer 100 such as a sheet position detection sensor, a temperature/humidity sensor, a density sensor or the like. The printer 100 further includes a head control unit that sends the image data stored in the image data editing memory to the LED head 40 and controls the LED head 40. The printer 100 further includes a temperature control unit that controls the temperature of the fixing unit 42, a feeding motor control unit that controls the driving motors for rotating respective rollers for feeding the sheet P, and a drive control unit that controls driving motors for rotating photosensitive drum 21 and other rollers, and high-voltage power sources for applying voltages to the respective rollers, or the like.

Next, the developing device 20 will be described with reference to FIG. 2. FIG. 2 is a schematic view showing a configuration of the developing device 20.

In FIG. 2, the photosensitive drum 21 as an image bearing body (also referred to as a latent image bearing body) includes a conductive support and a photoconductive layer formed thereon. The conductive support is composed of a metal pipe of aluminum. The photoconductive layer is composed of an organic photosensitive body including an electron generation layer and an electron transporting layer laminated on the metal pipe. A charging roller 22 is disposed contacting the circumferential surface of the photosensitive drum 21, and includes a metal shaft and a semiconductive epichlorohydrin rubber. A cleaning roller is disposed at a predetermined position along the circumference of the photosensitive drum 21. The cleaning roller 26 is provided for removing the residual toner remaining on the circumferential surface of the photosensitive drum 21.

A developing roller 23 as a developer bearing body is pressed against the circumferential surface of the photosensitive drum 21. The developing roller 23 includes a metal core (i.e., a metal shaft) of stainless steel or the like covered with a semiconductive silicone rubber in which carbon black is dispersed. A developing blade 24 is disposed at a predetermined position along the circumference of the developing roller 23. The developing blade 24 is formed of stainless steel, and regulates the thickness of a toner layer formed on the circumferential surface of the developing roller 23.

A sponge roller 25 as a developer supplying body is disposed contacting the circumferential surface of the developing roller 23, and includes a metal shaft covered with a semiconductive foaming silicone sponge layer.

As shown in FIG. 2, the photosensitive drum 21 is driven by the driving motor (not shown) to rotate at a constant speed in a direction shown by an arrow (a) in FIG. 2. The charging roller 22, which is disposed contacting the circumferential surface of the photosensitive drum 21, rotates in a direction shown by an arrow (b) in FIG. 2, and applies a charging bias of −1000V (supplied by a not shown high-voltage power source for the charging roller 22) to the surface of the photosensitive drum 21 so as to uniformly charge the surface of the photosensitive drum 21. The LED head 40 disposed facing the photosensitive drum 21 exposes the uniformly charged surface of the photosensitive drum 21 according to image signal. Electric potentials of exposed parts on the surface of the photosensitive drum 21 optically attenuate, so that a latent image is formed on the surface of the photosensitive drum 21. In this regard, the electric potential of the exposed part (exposed by the LED head 40) on the photosensitive drum 21 is, for example, −50V, and the electric potential of the non-exposed part on the photosensitive drum 21 is, for example, −500 V.

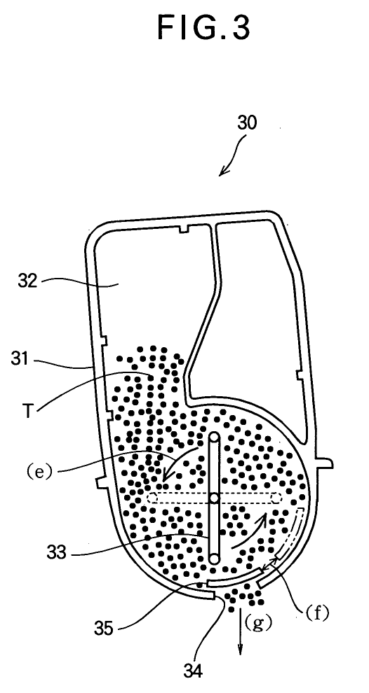

The developing roller 23 is disposed tightly contacting the photosensitive drum 21, and is applied with a developing bias of −200 V by a not shown high-voltage power source for the developing roller 23. The developing roller 23 absorbs the toner T having been carried by the sponge roller 25 applied with a supply voltage of −300V, and rotates to carry the toner T in a direction indicated by arrow (c) in FIG. 3. According to the rotation of the developing roller 23, the developing blade 24 disposed contacting the developing roller 23 on the downstream side of the sponge roller 25 forms a layer of the toner adhering to the developing roller 23 (i.e., a toner layer) having a uniform thickness.

Further, the developing roller 23 reversely develops the latent image on the photosensitive drum 21 using the toner T (to be more specific, a single-component toner) borne by the developing roller 23. A bias voltage is applied to between the conductive support of the photosensitive drum 21 and the developing roller 23, and therefore electrical lines of force are generated due to the latent image on the photosensitive drum 21. The charged toner T on the developing roller 23 adheres to the latent image on the photosensitive drum 21 due to electrostatic force, and develops the latent image to form a toner image. The developing process (from the rotation of the photosensitive drum 21) starts at a predetermined timing.

Next, the toner cartridge 30 will be described with reference to FIG. 3. FIG. 3 is a schematic view showing the toner cartridge 30.

As shown in FIG. 3, the toner cartridge 30 includes a container 31 having a toner storing portion (i.e., a developer storing portion) 32. An agitation bar 33 is disposed at a predetermined position inside the toner storing portion 32. The agitation bar 33 extends in the longitudinal direction of the toner cartridge 30, and rotates in a direction shown by an arrow (e) in FIG. 3. The toner cartridge 30 has an outlet opening 34 for ejecting the toner T. The outlet opening 34 is disposed at a bottom of the container 31 below the agitation bar 33. A shutter (i.e., an opening-and-closing member) 35 is provided in the container 31 so as to be slidable in a direction indicated by an arrow (f) for opening and closing the outlet opening 34.

In a state where the toner cartridge 30 is mounted to the main body 20a of the developing device 20 as shown in FIG. 2, the shutter 35 is slid in the direction shown by the arrow (f) by operation of a not shown lever. As the shutter 35 is slid, the toner T stored in the container 31 falls in a direction shown by an arrow (g) via the outlet opening 34, and is supplied to the developing device 20 shown in FIG. 2. The toner T supplied to the developing device 20 is supplied to the developing roller 23 by means of the sponge roller 25 rotating in a direction shown by an arrow (d) applied with a voltage by a not shown high-voltage power source for the sponge roller 25.

Next, an image forming process of the printer 100 will be described.

As shown in FIG. 1, the sheet P stored in the sheet cassette 11 is individually fed out of the sheet cassette 11 by the hopping roller 12 in the direction shown by the arrow (x) in FIG. 1. Then, the sheet P is fed to the developing device 20 by the first pair of rollers (i.e., the feeding roller 13, the pinch roller 14) and the second pair of rollers (i.e., the registration roller 15 and the pinch roller 16) while the skew of the sheet P is corrected. The developing process starts at a predetermined timing while the sheet P is fed in the direction shown by the arrow (y) in FIG. 2.

As shown in FIG. 2, the transfer roller 41 to which the transfer voltage is applied by a not shown high-voltage power source (for the transfer roller 41) performs the transferring process for transferring the toner image from the photosensitive drum 21 to the sheet P.

Thereafter, the sheet P is fed to the fixing unit 42 including the heat roller 43 and the backup roller 44. The sheet P with the transferred toner image is fed into between the heat roller 43 and the backup roller 44 respectively rotating in directions indicated by arrows (h) and (i). The toner on the sheet P is molten by the heat of the heat roller 43, and is fixed to the sheet P by being pressed by the heat roller 43 and the backup roller 44. That is, the toner image is fixed to the sheet P.

The sheet P with the fixed toner image is fed by the feeding roller 46 and the pinch roller 47, and is ejected by the ejection roller 48 and the pinch roller 49, so that the sheet P is ejected to the sheet stacker 50.

In this regard, there are cases where the toner T slightly remains on the surface of the photosensitive drum 21 after the toner image is transferred to the sheet P. Such residual toner T is removed by the cleaning roller 26. The cleaning roller 26 is disposed contacting the surface of the photosensitive drum 21 at a predetermined position, and rotates following the rotation of the photosensitive drum 21. As the photosensitive drum 21 rotates in a state where the cleaning roller 26 contacts the surface of the photosensitive drum 21, the residual toner T is removed from the surface of the photosensitive drum 21. The photosensitive drum 21 from which the residual toner T is removed (i.e., cleaned) is repeatedly used.

Next, the toner T will be described.

The toner T is a polymerization toner manufactured by dispersing a coloring agent, an additive agent and a monomer in aqueous medium to cause polymerization. Hereinafter, a description will be made of the toner T manufactured by suspension polymerization method by which spherically-shaped toner can be obtained by a single-step reaction.

The toner T contains a resin, to be more specific, a thermoplastic resin such as vinyl resin, polyamide resin, polyester resin or the like. The vinyl resin is constituted by monomer such as, for example, styrene or styrene derivative such as 2,4-dimethylstyrene, α-methylstyrene, p-ethylstyrene, o-methylstyrene, m-methylstyrene, p-methylstyrene, p-chlorostyrene, vinyl naphthalene or the like. Further, the monomer (constituting the vinyl resin) can be ethylene monocarbonic acid and ester thereof such as 2-ethylhexyl acrylate, methyl methacrylate, acrylic acid, methyl acrylate, ethyl acrylate, n-propyl acrylate, isobutyl acrylate, t-butyl acrylate, amyl acrylate, cyclohexyl acrylate, n-octyl acrylate, isooctyl acrylate, decyl acrylate, lauryl acrylate, stearyl acrylate, methoxyethyl acrylate, 2-hydroxyethyl acrylate, glycidyl acrylate, phenyl acrylate, α-chloro methyl acrylate, methacrylic acid, ethyl metacrylate, n-propyl methacrylate, isopropyl methacrylate, n-butyl methacrylate, isobutyl methacrylate, t-butyl methacrylate, amyl methacrylate, cyclohexyl methacrylate, n-octyl methacrylate, isooctyl methacrylate, decyl methacrylate, lauryl methacrylate, 2-ethylhexyl methacrylate, stearyl methacrylate, methoxyethyl methacrylate, 2-hydroxyethyl methacrylate, glycidyl methacrylate, phenyl methacrylate, dimethyl amino ethyl methacrylate, diethyl amino ethyl methacrylate or the like. Further, the monomer (constituting the vinyl resin) can be, for example, ethylene-based unsaturated monoolefin such as ethylene, propylene, butylene, isobutylene or the like. The monomer (constituting the vinyl resin) can be, for example, ethylene monocarbonic acid substitution such as vinyl chloride, vinyl bromide, vinyl acetate, vinyl propionate, vinyl formate, vinyl caproate or the like. Further, the monomer (constituting the vinyl resin) can be, for example, ethylene dicarboxylic acid such as maleic acid or its derivative, vinyl ketone such as vinyl methyl ketone, or vinyl ether such as vinyl methyl ether.

The toner T can contain a cross linker. As the cross linker, it is possible to use a general cross linker such as divinyl benzene, divinyl naphthalene, polyethylene glycol dimethacrylate, 2,2-bis-(4-methacryloxy-diethoxy-phenyl) propane, 2,2-bis-(4-acryloxy-diethoxy-phenyl) propane, diethylene glycol diacrylate, triethylene glycol diacrylate, 1,3-butylene glycol dimethacrylate, 1,6-hexylene glycol dimethacrylate, neopentyl glycol dimethacrylate, neopentyl glycol dimethacrylate, dipropylene glycol dimethacrylate, polypropylene glycol dimethacrylate, trimethylolpropane trimethacrylate, trimethylolpropane triacrylate, tetramethylol methane tetraacrylate or the like alone or in combination thereof as needed.

As the coloring agent, it is possible to use pigment or dye generally used in black toner or color toner, such as carbon black, iron oxide, phthalocyanine blue, permanent brown FG, brilliant fast scarlet, pigment green B, rhodamine B base, solvent red 49, solvent red 146, pigment blue 15:3, solvent blue 35, quinacridone, carmine 6B, disazo yellow, or the like.

The toner T can contain an offset preventing agent. In this regard, it is possible to use a conventional offset preventing agent, for example, fatty series carbohydrate wax such as low molecular polyethylene, low molecular polypropylene, olefin copolymer, micro crystalline wax, paraffin wax, Fischer-Tropsch wax, oxide of fatty series carbohydrate wax such as polyethylene oxide wax or block copolymer thereof, fatty series ester-based wax such as carnauba wax and montanic acid ester wax, or deoxidized fatty series ester such as deoxidized carnauba wax.

The toner T contains external additives. As the external additives, it is preferable to use inorganic fine powder for enhancing environmental stability, charge stability, developing property, fluidity, and preserving property. As inorganic fine powder, it is possible to use oxide of metal such as zinc, aluminum, cerium, cobalt, iron, zirconium, chrome, manganese, strontium, tin, antimony, combined metal oxide such as calcium titanate, magnesium titanate, strontium titanate, metal salt such as barium sulfate, calcium carbonate, magnesium carbonate, aluminum carbonate, clay mineral such as kaolin, phosphate compound such as apatite, silicide such as silica, silicon carbide, silicon nitride, carbon fine powder such as carbon black or graphite.

The toner T can further contain a charge controlling agent, a conductivity adjusting agent, an extender pigment, a reinforcing filler such as fibrous substance, an oxidation preventing agent, an anti-aging preventing agent, a fluidity enhancing agent or the like as needed.

### Example 1

The toner T according to Example 1 was manufactured as suspension polymerization toner as follows:

77.5 weight parts of styrene, 22.5 weight parts of n-butyl acrylate, 2 weight parts of low molecular polystyrene as an offset preventing agent, 1 weight part of Aizen Spilon Black (manufactured by Hodogaya Chemical Co., Ltd) as a charge controlling agent, 6 weight parts of carbon black (“Printex L” manufactured by Degussa Inc.), and 1 weight part of azobisisobutyronitrile were mixed and dispersed at a temperature of 15° C. for 10 hours in an “attritor MA-01SC” (manufactured by Mitsui Miike Kakouki Co., Ltd.), so as to obtain a polymer composition.

Aside from this, 180 weight parts of ethanol in which 8 weight parts of polyacrylic acid and 0.35 weight parts of divinyl benzene were dissolved was prepared. Then, 600 weight parts of distilled water was added to the ethanol, so as to obtain a dispersion medium for polymerization.

Then, the above described polymer composition was added to the dispersion medium and was dispersed at a temperature of 15° C. and at a rotation speed of 8000 rpm for 10 minutes in a TK homo mixer “M-type” (manufactured by Tokushu-Kika Kogyo Co., Ltd.). Then, the resulting dispersion solution was put into a separable flask of 1 litter, and was agitated under nitrogen atmosphere at a temperature of 80° C. and at a rotation speed of 1000 rpm for 12 hours so as to cause polymerization. A dispersoid was obtained using this polymerization, and the dispersoid is referred to as intermediate particles.

Then, an aqueous emulsion A containing 9.25 weight parts of methyl methacrylate, 0.75 weight parts of n-butyl acrylate, 0.5 weight parts of 2,2′-azobisisobutyronitrile, 0.1 weight parts of sodium lauryl sulfate, and 80 weight parts of distilled water was prepared. Then, the above described dispersion solution (in which the intermediate particles are dispersed) was vibrated using a ultrasonic vibration disperser “US 150” (manufactured by Nippon Seiki Seisakusho Co., Ltd.), and 9 weight parts of the aqueous emulsion A in the form of droplets was dropped in the dispersion solution, so that the intermediate particles were swollen. As a result of observation of the intermediate particles using an optical telescope after the dropping, the droplets of emulsion were not observed, and therefore it was found that the swelling of the intermediate particles was completed in a short time.

Then, the dispersion solution was further agitated under nitrogen atmosphere at a temperature of 85° C. for 9.5 hours, so as to cause a second-step polymerizing reaction. After the completion of the reaction, the dispersion solution was cooled. Then, the above described dispersion solution (to which the aqueous emulsion A was added) was dissolved in hydrochloric solution of 0.5N, filtered, washed, air-dried and further dried under reduced pressure (at a pressure of 10 mmHg) and at a temperature of 40° C. for 10 hours. Thereafter, the resulting material was classified using a wind classifier. As a result, the toner mother particles whose mean volume diameter is 6.5 μm were obtained. These toner mother particles are referred to as toner mother particles A.

In this regard, the mean volume diameter of the toner mother particles can be measured by means of measuring equipment using “Coulter Counter TA-2” or “Coulter Multisizer 2” (manufactured by Beckman Coulter Co., Ltd.) connected to an interface for outputting number-size distribution (manufactured by Nikkaki Co., Ltd.) and volumetric distribution, and a personal computer. This measurement can be performed using an electrolytic aqueous solution such as NaCl aqueous solution of 1% prepared using first level sodium chloride or ISOTON R-II (manufactured by Coulter Scientific Japan Co., Ltd.) or the like.

The mean volume diameter was measured as follows. First, 0.1 to 5 ml of a surface-active agent (preferably alkyl benzene sulfonate) as dispersion liquid was added to 100 ml to 150 ml of an electrolytic aqueous solution. Then, 2 to 20 mg of a specimen (i.e., toner mother particles) was added to the electrolytic aqueous solution. Thereafter, the electrolytic aqueous solution containing the specimen was dispersed for approximately 1 minute using an ultrasonic disperser. Using the above described “Coulter Counter TA-2” with an aperture having a diameter of 100 μm, a volume of the toner mother particles was measured, and a volumetric distribution was calculated. Based on the calculated volumetric distribution, the mean volume diameter of the toner mother particles was determined.

Toner mother particles B, C and D were manufactured in substantially the same manner as the above described toner mother particles A except the condition of the second-step polymerizing reaction.

The toner mother particles B were manufactured via the second polymerizing reaction of the aqueous emulsion A at a temperature of 85° C. for 10 hours. The mean volume diameter of the toner mother particles B was 7.0 μm.

The toner mother particles C were manufactured via the second polymerizing reaction of the aqueous emulsion A at a temperature of 85° C. for 10.5 hours. The mean volume diameter of the toner mother particles C was 7.5 μm.

The toner mother particles D were manufactured via the second polymerizing reaction of the aqueous emulsion A at a temperature of 85° C. for 11 hours. The mean volume diameter of the toner mother particles D was 8.0 μm.

TABLE 1 shows the temperatures of the second polymerizing reaction (i.e., reaction temperatures), times of the second polymerizing reaction (i.e., reaction times), and the mean volume diameters of the toner mother particles A, B, C and D.

TABLE 1

| TONER | REACTION | REACTION | MEAN VOLUME |
|---|---|---|---|
| MOTHER | TEMPERATURE | TIME | DIAMETER |
| PARTICLES | (° C.) | (hr) | (μm) |
| A | 85.0 | 9.5 | 6.5 |
| B | 85.0 | 10.0 | 7.0 |
| C | 85.0 | 10.5 | 7.5 |
| D | 85.0 | 11.0 | 8.0 |

Next, the following toners A-1 to D-15 were manufactured by adding “Aerosil RX 50” (manufactured by Nippon Aerosil Co., Ltd.) as dry silica (i.e., external additives) to 100 weight parts of the toner mother particles A, B, C and D and by respectively dispersing the resulting materials for predetermined times.

### Example 1-1

The toner A-1 was manufactured by adding 1.5 weight parts of “Aerosil RX 50” to 100 weight parts of the toner mother particles A and mixing the resulting material for 20 minutes. The mean volume diameter of the toner A-1 was 6.5 μm.

### Example 1-2

The toner D-1 was manufactured by adding 1.5 weight parts of “Aerosil RX 50” to 100 weight parts of the toner mother particles D and mixing the resulting material for 25 minutes. The mean volume diameter of the toner D-1 is 8.0 μm.

### Example 1-3

The toner D-2 was manufactured by adding 1.5 weight parts of “Aerosil RX 50” to 100 weight parts of the toner mother particles D and mixing the resulting material for 10 minutes. The mean volume diameter of the toner D-2 was 8.0 μm.

### Example 1-4

The toner A-3 was manufactured by adding 1.8 weight parts of “Aerosil RX 50” to 100 weight parts of the toner mother particles A and mixing the resulting material for 25 minutes. The mean volume diameter of the toner A-3 was 6.5 μm.

### Example 1-5

The toner B-2 was manufactured by adding 1.8 weight parts of “Aerosil RX 50” to 100 weight parts of the toner mother particles B and mixing the resulting material for 25 minutes. The mean volume diameter of the toner B-2 was 7.0 μm.

### Example 1-6

The toner C-2 was manufactured by adding 1.8 weight parts of “Aerosil RX 50” to 100 weight parts of the toner mother particles C and mixing the resulting material for 25 minutes. The mean volume diameter of the toner C-2 was 7.5 μm.

### Example 1-7

The toner D-3 was manufactured by adding 1.8 weight parts of “Aerosil RX 50” to 100 weight parts of the toner mother particles D and mixing the resulting material for 25 minutes. The mean volume diameter of the toner D-3 was 8.0 μm.

### Example 1-8

The toner A-4 was manufactured by adding 2.1 weight parts of “Aerosil RX 50” to 100 weight parts of the toner mother particles A and mixing the resulting material for 25 minutes. The mean volume diameter of the toner A-4 was 6.5 μm.

### Example 1-9

The toner B-3 was manufactured by adding 2.1 weight parts of “Aerosil RX 50” to 100 weight parts of the toner mother particles B and mixing the resulting material for 25 minutes. The mean volume diameter of the toner B-3 was 7.0 μm.

### Example 1-10

The toner C-3 was manufactured by adding 2.1 weight parts of “Aerosil RX 50” to 100 weight parts of the toner mother particles C and mixing the resulting material for 25 minutes. The mean volume diameter of the toner C-3 was 7.5 μm.

### Example 1-11

The toner D-4 was manufactured by adding 2.1 weight parts of “Aerosil RX 50” to 100 weight parts of the toner mother particles D and mixing the resulting material for 25 minutes. The mean volume diameter of the toner D-4 was 8.0 μm.

### Example 1-12

The toner A-5 was manufactured by adding 2.4 weight parts of “Aerosil RX 50” to 100 weight parts of the toner mother particles A and mixing the resulting material for 25 minutes. The mean volume diameter of the toner A-5 was 6.5 μm.

### Example 1-13

The toner B-4 was manufactured by adding 2.4 weight parts of “Aerosil RX 50” to 100 weight parts of the toner mother particles B and mixing the resulting material for 25 minutes. The mean volume diameter of the toner B-4 was 7.0 μm.

### Example 1-14

The toner C-4 was manufactured by adding 2.4 weight parts of “Aerosil RX 50” to 100 weight parts of the toner mother particles C and mixing the resulting material for 25 minutes. The mean volume diameter of the toner C-4 was 7.5 μm.

### Example 1-15

The toner D-5 was manufactured by adding 2.4 weight parts of “Aerosil RX 50” to 100 weight parts of the toner mother particles D and mixing the resulting material for 25 minutes. The mean volume diameter of the toner D-5 was 8.0 μm.

### Example 1-16

The toner A-6 was manufactured by adding 2.7 weight parts of “Aerosil RX 50” to 100 weight parts of the toner mother particles A and mixing the resulting material for 25 minutes. The mean volume diameter of the toner A-6 was 6.5 μm.

### Example 1-17

The toner B-5 was manufactured by adding 2.7 weight parts of “Aerosil RX 50” to 100 weight parts of the toner mother particles B and mixing the resulting material for 25 minutes. The mean volume diameter of the toner B-5 was 7.0 μm.

### Example 1-18

The toner C-5 was manufactured by adding 2.7 weight parts of “Aerosil RX 50” to 100 weight parts of the toner mother particles C and mixing the resulting material for 25 minutes. The mean volume diameter of the toner C-5 was 7.5 μm.

### Example 1-19

The toner D-6 was manufactured by adding 2.7 weight parts of “Aerosil RX 50” to 100 weight parts of the toner mother particles D and mixing the resulting material for 25 minutes. The mean volume diameter of the toner D-6 was 8.0 μm.

### Example 1-20

The toner A-7 was manufactured by adding 3.0 weight parts of “Aerosil RX 50” to 100 weight parts of the toner mother particles A and mixing the resulting material for 25 minutes. The mean volume diameter of the toner A-7 was 6.5 μm.

### Example 1-21

The toner D-8 was manufactured by adding 3.0 weight parts of “Aerosil RX 50” to 100 weight parts of the toner mother particles D and mixing the resulting material for 40 minutes. The mean volume diameter of the toner D-8 was 8.0 μm.

### Example 1-22

The toner A-8 was manufactured by adding 1.5 weight parts of “Aerosil RX 50” to 100 weight parts of the toner mother particles A and mixing the resulting material for 15 minutes. The mean volume diameter of the toner A-8 was 6.5 μm.

### Example 1-23

The toner A-9 was manufactured by adding 1.5 weight parts of “Aerosil RX 50” to 100 weight parts of the toner mother particles A and mixing the resulting material for 10 minutes. The mean volume diameter of the toner A-9 was 6.5 μm.

### Example 1-24

The toner B-7 was manufactured by adding 1.5 weight parts of “Aerosil RX 50” to 100 weight parts of the toner mother particles B and mixing the resulting material for 15 minutes. The mean volume diameter of the toner B-7 was 7.0 μm.

### Example 1-25

The toner A-10 was manufactured by adding 1.8 weight parts of “Aerosil RX 50” to 100 weight parts of the toner mother particles A and mixing the resulting material for 15 minutes. The mean volume diameter of the toner A-10 was 6.5 μm.

### Example 1-26

The toner B-8 was manufactured by adding 1.8 weight parts of “Aerosil RX 50” to 100 weight parts of the toner mother particles B and mixing the resulting material for 15 minutes. The mean volume diameter of the toner B-8 was 7.0 μm.

### Example 1-27

The toner A-11 was manufactured by adding 2.1 weight parts of “Aerosil RX 50” to 100 weight parts of the toner mother particles A and mixing the resulting material for 15 minutes. The mean volume diameter of the toner A-11 was 6.5 μm.

### Example 1-28

The toner C-10 was manufactured by adding 2.4 weight parts of “Aerosil RX 50” to 100 weight parts of the toner mother particles C and mixing the resulting material for 35 minutes. The mean volume diameter of the toner C-10 was 7.5 μm.

### Example 1-29

The toner D-12 was manufactured by adding 2.4 weight parts of “Aerosil RX 50” to 100 weight parts of the toner mother particles D and mixing the resulting material for 35 minutes. The mean volume diameter of the toner D-12 was 8.0 μm.

### Example 1-30

The toner C-11 was manufactured by adding 2.7 weight parts of “Aerosil RX 50” to 100 weight parts of the toner mother particles C and mixing the resulting material for 35 minutes. The mean volume diameter of the toner C-11 was 7.5 μm.

### Example 1-31

The toner D-13 was manufactured by adding 2.7 weight parts of “Aerosil RX 50” to 100 weight parts of the toner mother particles D and mixing the resulting material for 35 minutes. The mean volume diameter of the toner D-13 was 8.0 μm.

### Example 1-32

The toner A-14 was manufactured by adding 3.0 weight parts of “Aerosil RX 50” to 100 weight parts of the toner mother particles A and mixing the resulting material for 35 minutes. The mean volume diameter of the toner A-14 was 6.5 μm.

### Example 1-33

The toner B-12 was manufactured by adding 3.0 weight parts of “Aerosil RX 50” to 100 weight parts of the toner mother particles B and mixing the resulting material for 35 minutes. The mean volume diameter of the toner B-12 was 7.0 μm.

### Example 1-34

The toner C-12 was manufactured by adding 3.0 weight parts of “Aerosil RX 50” to 100 weight parts of the toner mother particles C and mixing the resulting material for 35 minutes. The mean volume diameter of the toner C-12 was 7.5 μm.

### Example 1-35

The toner D-14 was manufactured by adding 3.0 weight parts of “Aerosil RX 50” to 100 weight parts of the toner mother particles D and mixing the resulting material for 35 minutes. The mean volume diameter of the toner D-14 was 8.0 μm.

### Example 1-36

The toner D-15 was manufactured by adding 3.0 weight parts of “Aerosil RX 50” to 100 weight parts of the toner mother particles D and mixing the resulting material for 20 minutes. The mean volume diameter of the toner D-15 was 8.0 μm.

### [Comparison 1-1]

The toner A-2 was manufactured by adding 1.5 weight parts of “Aerosil RX 50” to 100 weight parts of the toner mother particles A and mixing the resulting material for 25 minutes. The mean volume diameter of the toner A-2 was 6.5 μm.

### [Comparison 1-2]

The toner B-1 was manufactured by adding 1.5 weight parts of “Aerosil RX 50” to 100 weight parts of the toner mother particles B and mixing the resulting material for 25 minutes. The mean volume diameter of the toner B-1 was 7.0 μm.

### [Comparison 1-3]

The toner C-1 was manufactured by adding 1.5 weight parts of “Aerosil RX 50” to 100 weight parts of the toner mother particles C and mixing the resulting material for 25 minutes. The mean volume diameter of the toner C-1 was 7.5 μm.

### [Comparison 1-4]

The toner B-6 was manufactured by adding 3.0 weight parts of “Aerosil RX 50” to 100 weight parts of the toner mother particles B and mixing the resulting material for 25 minutes. The mean volume diameter of the toner B-6 was 7.0 μm.

### [Comparison 1-5]

The toner C-6 was manufactured by adding 3.0 weight parts of “Aerosil RX 50” to 100 weight parts of the toner mother particles C and mixing the resulting material for 25 minutes. The mean volume diameter of the toner C-6 was 7.5 μm.

### [Comparison 1-6]

The toner D-7 was manufactured by adding 3.0 weight parts of “Aerosil RX 50” to 100 weight parts of the toner mother particles D and mixing the resulting material for 25 minutes. The mean volume diameter of the toner D-7 was 8.0 μm.

### [Comparison 1-7]

The toner C-7 was manufactured by adding 1.5 weight parts of “Aerosil RX 50” to 100 weight parts of the toner mother particles C and mixing the resulting material for 15 minutes. The mean volume diameter of the toner C-7 was 7.5 μm.

### [Comparison 1-8]

The toner D-9 was manufactured by adding 1.5 weight parts of “Aerosil RX 50” to 100 weight parts of the toner mother particles D and mixing the resulting material for 15 minutes. The mean volume diameter of the toner D-9 was 8.0 μm.

### [Comparison 1-9]

The toner C-8 was manufactured by adding 1.8 weight parts of “Aerosil RX 50” to 100 weight parts of the toner mother particles C and mixing the resulting material for 15 minutes. The mean volume diameter of the toner C-8 was 7.5 μm.

### [Comparison 1-10]

The toner D-10 was manufactured by adding 1.8 weight parts of “Aerosil RX 50” to 100 weight parts of the toner mother particles D and mixing the resulting material for 15 minutes. The mean volume diameter of the toner D-10 was 8.0 μm.

### [Comparison 1-11]

The toner B-9 was manufactured by adding 2.1 weight parts of “Aerosil RX 50” to 100 weight parts of the toner mother particles B and mixing the resulting material for 15 minutes. The mean volume diameter of the toner B-9 was 7.0 μm.

### [Comparison 1-12]

The toner C-9 was manufactured by adding 2.1 weight parts of “Aerosil RX 50” to 100 weight parts of the toner mother particles C and mixing the resulting material for 15 minutes. The mean volume diameter of the toner C-9 was 7.5 μm.

### [Comparison 1-13]

The toner D-11 was manufactured by adding 2.1 weight parts of “Aerosil RX 50” to 100 weight parts of the toner mother particles D and mixing the resulting material for 15 minutes. The mean volume diameter of the toner D-11 was 8.0 μm.

### [Comparison 1-14]

The toner A-12 was manufactured by adding 2.4 weight parts of “Aerosil RX 50” to 100 weight parts of the toner mother particles A and mixing the resulting material for 35 minutes. The mean volume diameter of the toner A-12 was 6.5 μm.

### [Comparison 1-15]

The toner B-10 was manufactured by adding 2.4 weight parts of “Aerosil RX 50” to 100 weight parts of the toner mother particles B and mixing the resulting material for 35 minutes. The mean volume diameter of the toner B-10 was 7.0 μm.

### [Comparison 1-16]

The toner A-13 was manufactured by adding 2.7 weight parts of “Aerosil RX 50” to 100 weight parts of the toner mother particles A and mixing the resulting material for 35 minutes. The mean volume diameter of the toner A-13 was 6.5 μm.

### [Comparison 1-17]

The toner B-11 was manufactured by adding 2.7 weight parts of “Aerosil RX 50” to 100 weight parts of the toner mother particles B and mixing the resulting material for 35 minutes. The mean volume diameter of the toner B-11 was 7.0 μm.

Circularities of the above described toners A-1 through D-15 were greater than or equal to 0.97. In this regard, the circularities were measured by the following method. First, four to six droplets (approximately 0.5%) of neutral detergent were put in a beaker of 100 ml, and electrolytic solution of 100 ml was poured in the beaker. Then, the beaker was vibrated so that the neutral detergent was dissolved in the electrolytic solution, and then a heaping cupful toner T was put in the beaker using a spatula. Then, the beaker was vibrated using an ultrasonic bath for 60 seconds so as to disperse the toner T. The circularity of the toner T was measured using “Flow Particle Image Analyzer FPIA 2100” (manufactured by Sysmex Corp.) according to the following equation:

Circularity=L1/L2

where L1 represents a circumferential length of a circle having the same area as a projected image of the toner particle, and L2 represents a circumferential length of the projected image of the toner particle. If the circularity is 1, the form of the toner particle is a true sphere. As the circularity becomes smaller, the form of the toner particle becomes indefinite. For each kind of the toners A-1 to D-15, circularities of a plurality of toner particles were measured, and an average of the measured values was calculated.

Then, images of particle surfaces of the toners A-1 through D-15 were taken by means of a scanning probe microscope (SPM) manufactured by Shimadzu Corporation. Measurement conditions were as follows:

Diameter of Cantilever Probe: 10 nm

Measurement Mode Phase mode

Scanning Range: 1.0 μm×1.0

Based on the scanned image taken by the scanning probe microscope, a surface roughness Rzjis of the toner was obtained. For each kind of the toners A-1 to D-15, the surface roughness Rzjis of a plurality of toner particles were measured, and an average of the measured values was calculated. For example, the surface roughness Rzjis of the toner D-1 was 75.3 nm.

Further, a test was performed using the toners A-1 through D-15 in the printer 100 to thereby check occurrence of “drum fog”.

In the test, a circumferential speed of the developing roller 23 of the developing device 20 was set to 189.2 mm/s. A standard paper of A4 size (for example, “OKI excellent white paper” whose basis weight is 80 g/m²) was used as the sheet P. The sheet P was fed longitudinally, i.e., in such a manner that short edges of four edges of the sheet P became a leading edge and a trailing edge. Under these conditions, 100% duty images (i.e., black solid images) were printed on two pages, and then 0% duty image (i.e., a white image) was printed on one page.

Further, the developing device 20 was left unused for 1 week at a temperature of 24° C. and at a humidity of 40%. Thereafter, the developing device 20 was set in the printer 100. Then, the 100% duty images (black images) were printed on two pages, and the 0% duty image (white image) was printed on one page.

During the printing of the 0% duty image (after the non-use period of 1 week), the printer 100 was turned off. Then, the developing device 20 was taken out of the printer 100. In this state, a transparent mending tape was attached to the surface of the photosensitive drum 21, and was peeled off from the surface of the photosensitive drum 21 for causing the toner to be separated from the photosensitive drum 21. Then, the mending tape (referred to a sample tape) was attached to a white paper. For comparison, another mending tape (i.e., a reference tape) had been preliminarily attached to the same white paper. Then, a color phase difference between the sample tape and the reference tape was measured using a spectrophotometric colorimeter “CM-2600d” (manufactured by Konica-Minolta Ltd.) having a measurement diameter of 8 mm. The color-difference ΔY was calculated according to the following equation: ΔY={(L₁−L₂)²+(a₁−a₂)²+(b₁−b₂)²}^{1/2}. In this equation, L₁, a₁ and b₁ indicate chromaticity values of the sample tape having been peeled off from the photosensitive drum 21. L₂, a₂ and b₂ indicate chromaticity values of the reference tape. The measurements were performed at five points, and average value was obtained.

The “drum fog” is evaluated based on the color phase difference ΔY measured after the non-use period of 1 week as follows:

If the color phase difference ΔY (measured after the non-use period of 1 week) was less than 7.5, the evaluation result was “◯” (excellent).

If the color phase difference ΔY (measured after the non-use period of 1 week) was greater than or equal to 7.5, the evaluation result was “X” (poor).

Furthermore, based on the 100% duty image having been printed on the standard paper P (after the non-use period of 1 week) as described above, “image blurring” was evaluated as follows:

If the 100% duty image was printed entirely on the surface of the second page, the evaluation result was “◯” (i.e., excellent).

If there is a portion where the toner did not adhere to the sheet P in an area within 10 cm from the trailing edge of the sheet P to cause image blurring, the evaluation result was “X” (i.e., poor).

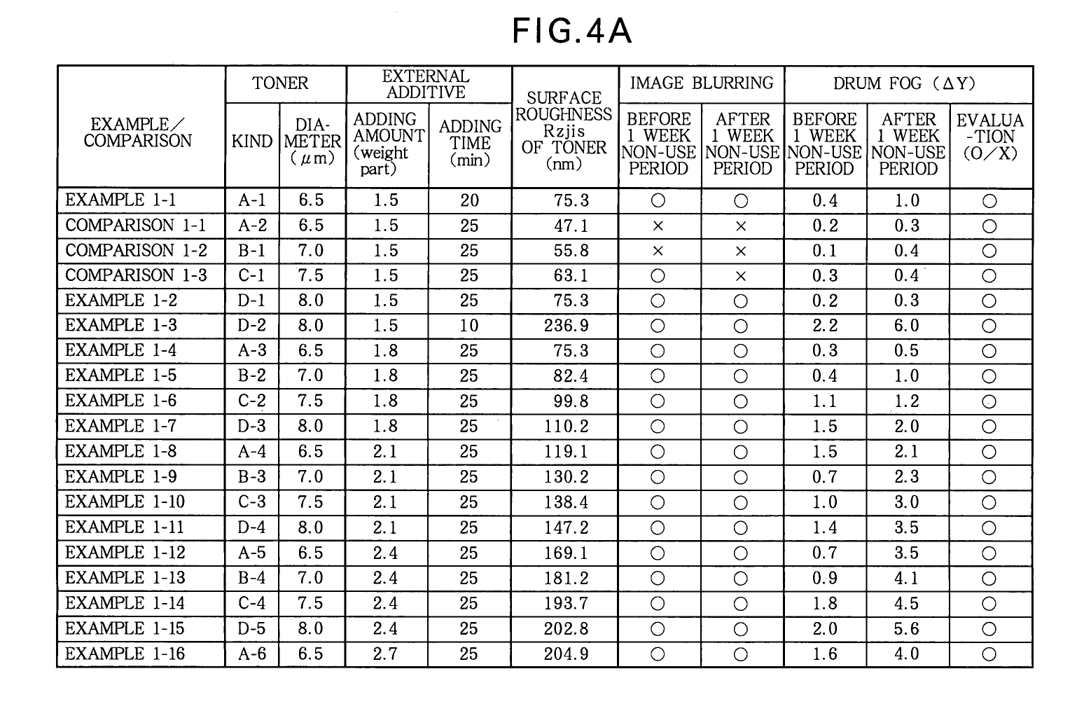

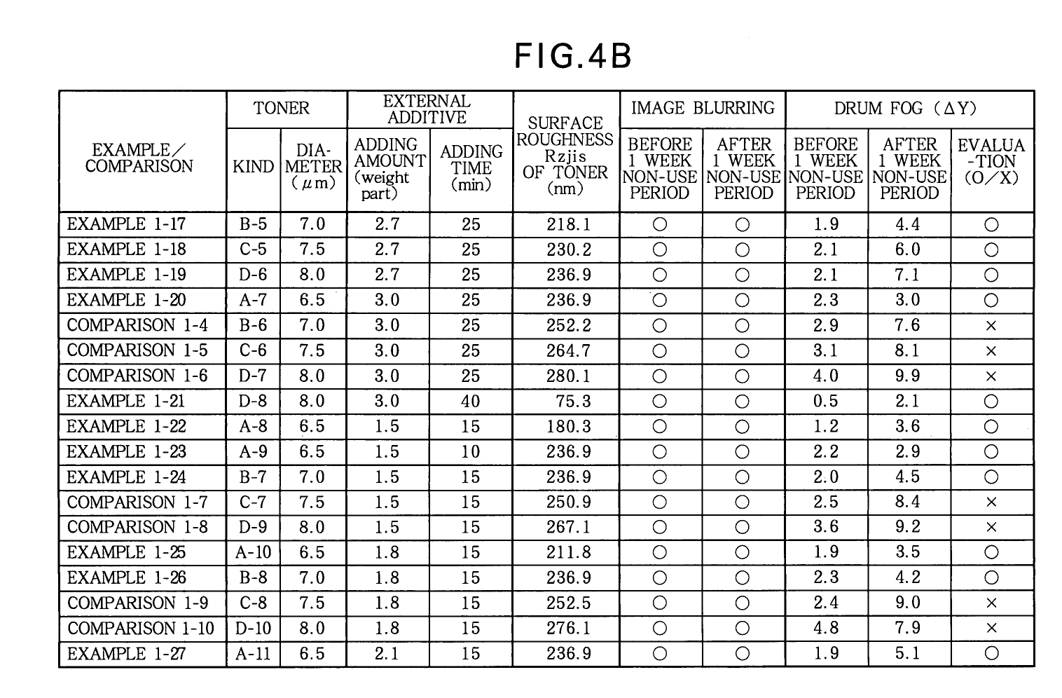

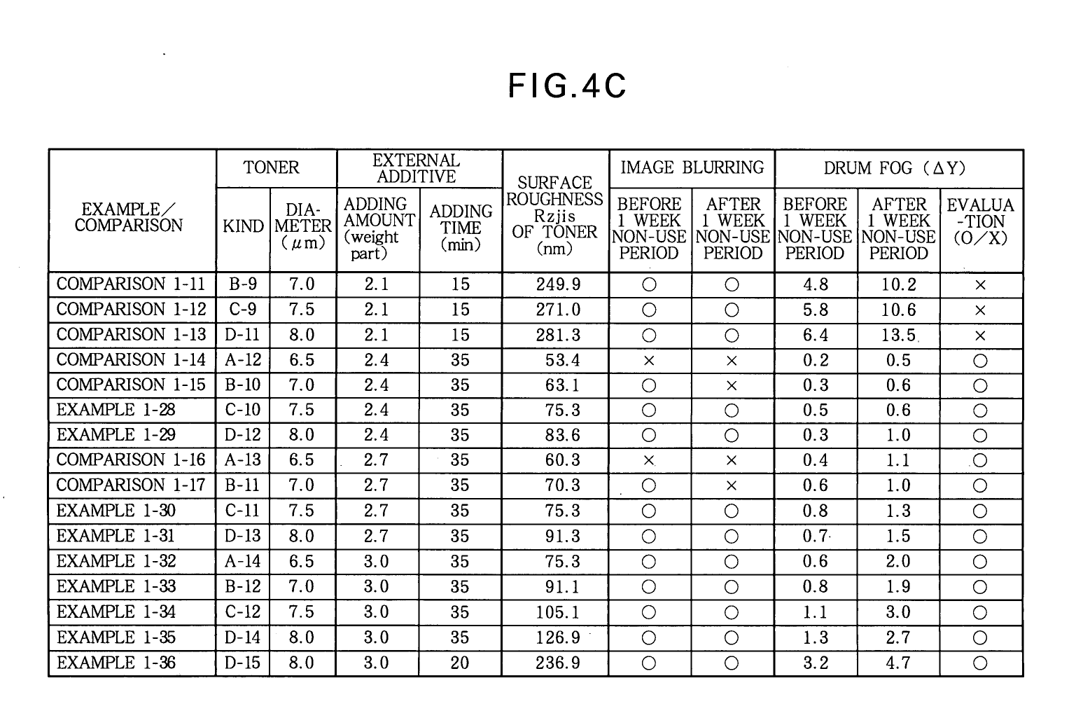

FIGS. 4A, 4B and 4C show the mean volume diameters, the surface roughness Rzjis measured using the scanning probe microscope, the evaluation results of the image blurring and the drum fog of the toners A-1 through D-15.

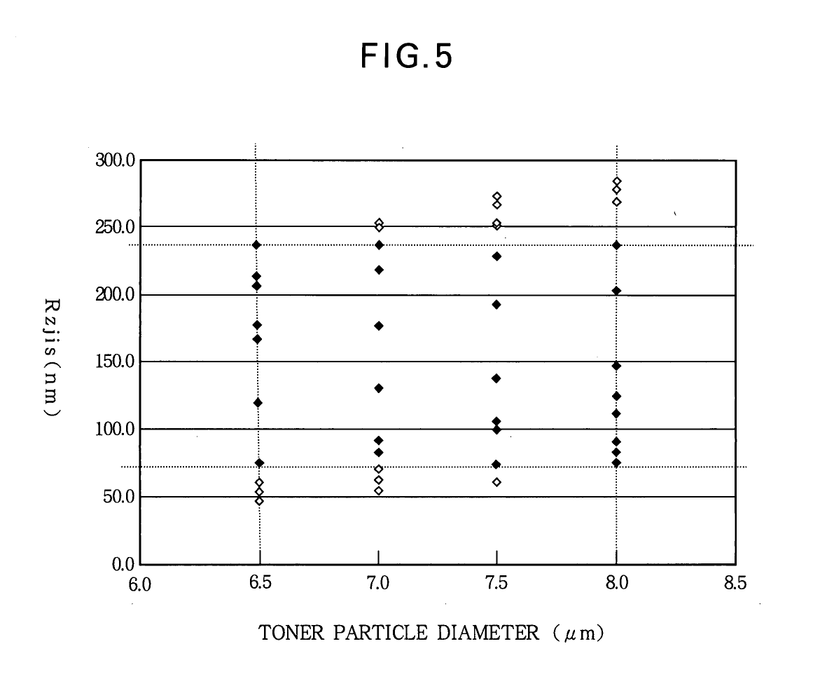

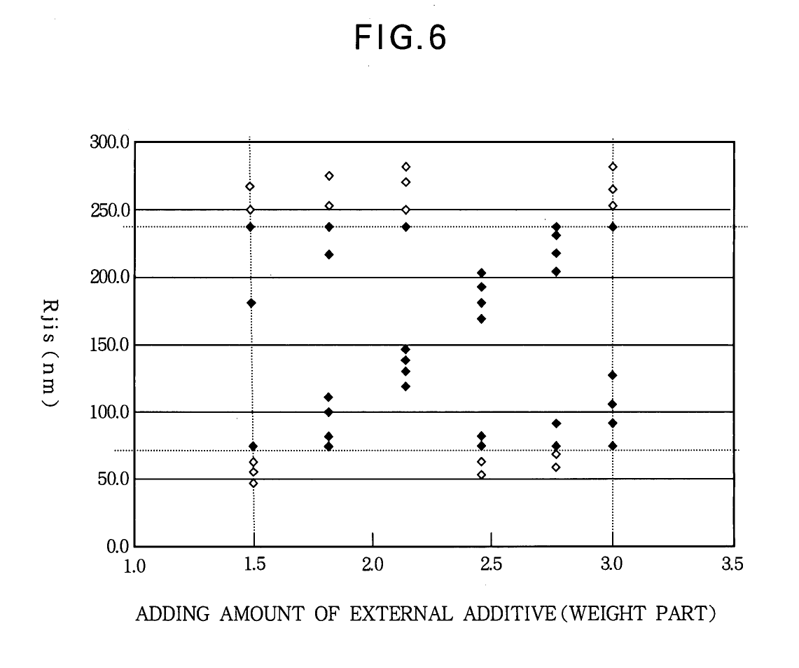

FIG. 5 is a graph showing the relationship between the mean volume diameter and the surface roughness Rzjis of the toner, and FIG. 6 is a graph showing the relationship between the adding amount of the external additives and the surface roughness Rzjis of the toner.

In FIGS. 5 and 6, black plots indicate that both evaluation results of the drum fog and the image blurring are excellent. White plots indicate that either or both of the evaluation results of the drum fog and the image blurring is poor.

Generally, if the mean volume diameter of the toner is less than 6.5 μm, since the toner size is small, the toner may leak out of the toner cartridge 30 or the developing device 20, and also the manufacturing cost of the toner may increase so that the toner may be unsuitable for mass production. On the other hand, if the mean volume diameter of the toner is greater than 8.0 μm, the image may become grainy, and it may become difficult to obtain fine and high quality image.

Further, if the adding amount of the external additives is less than 1.5 weight parts (with respect to 100 weight part of the toner mother particles), since the amount of the external additives added to the toner is small, fluidity of the toner may be degraded. In such a case, the toner may not be sufficiently supplied to the photosensitive drum 21, and fusion bonding between the toner particles may occur under high temperature and high humidity environment (for example, 28° C. and 80%) due to increase in areas of exposed surfaces of the toner mother particles. On the other hand, if the adding amount of the external additives is greater than 3.0 weight parts, fixing property of the toner with respect to the sheet P may be degraded due to increase in amount of external additives which are not thermally molten.

However, according to the first embodiment, the toner T has the mean volume diameter in a range from 6.5 to 8.0 μm, and the adding amount of the external additives is in a range from 1.5 to 3.0 weight parts with respect to 100 weight parts of the toner mother particles. Therefore, the above described problems can be solved.

In this regard, for example, when the surface roughness Rzjis of the toner is less than 75.3 nm (see, Comparisons 1-1 and 1-2), image blurring is observed in the 100% duty image. This is because the external additives are hardly held on such smooth surfaces of the toner mother particles, and the fluidity of the toner may be degraded. Further, for example, when the surface roughness Rzjis of the toner is greater than 236.9 nm (see, Comparisons 1-4 and 1-5), the drum fog occurs. This is because, due to large friction force at the surfaces of the toner particles, a torque of the developing device 20 may increase, and the toner may be insufficiently charged, so that reversely charged toner may increase.

As described above, according to the first embodiment, the toner is prepared in such a manner that the adding amount of the external additives is in a range from 1.5 to 3.0 weight parts, the mean volume diameter of the toner is in a range from 6.5 to 8.0 μm, and the surface roughness Rzjis of the toner as measured using the scanning probe microscope is in a range from 75.3 to 236.9 nm. Therefore, it becomes possible to suppress the occurrence of the fog and image blurring even when the image forming process is performed after a long period of non-use.

### Second Embodiment

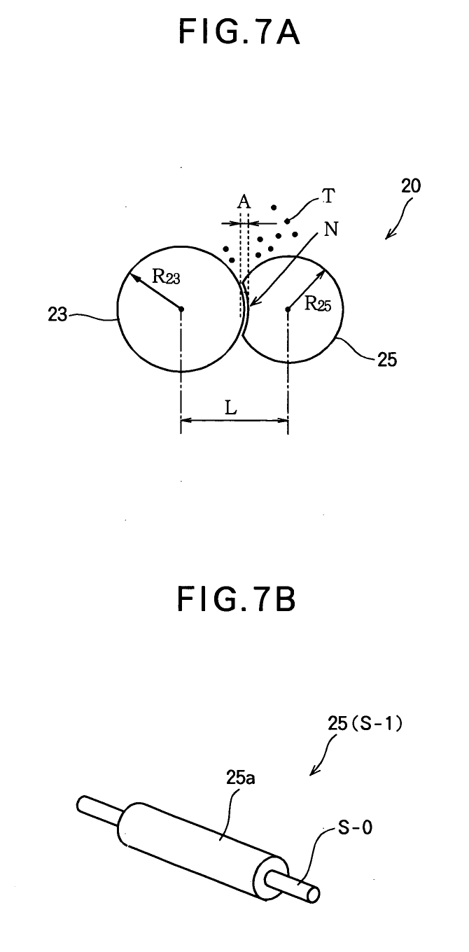

In the second embodiment of the present invention, a focus is placed on a friction force between the sponge roller 25 and the developing roller 23. To be more specific, using the sponge rollers 23 with different Asker hardness, the same test as in the first embodiment is performed under high temperature and high humidity environment (28° C., 80%). An amount (i.e., a pushing amount) A with which the sponge roller 25 is pushed into the developing roller 23 is set to 1.5 mm. As shown in FIG. 7A, the pushing amount A is determined by the following equation:

A=R₂₃+R₂₅−L,

where R₂₃ indicates a radius of the developing roller 23, R₂₅ indicates a radius of the sponge roller 25, and L indicates a distance between center axes of the developing roller 23 and the sponge roller 25.

Other structures of the developing device 20 and the printer 100 are the same as those of the first embodiment.

Next, a manufacturing method of the sponge roller 25 according to the second embodiment will be described with reference to FIG. 7B.

First, 10 weight parts of diatomite “OPLITE W-305S” having mean particle diameter of 6 μm (manufactured by Hokushu Keisodo Co., Ltd.), 2 weight parts of organo hydrogen polysiloxane as a cross linker, 5 weight parts of dimethyl 1-1 azobis (1-cyclohexane carboxylate) as a foaming agent, and chloroplatinic acid as a vulcanization catalyst were added to 100 weight parts of silicone rubber compound (“KE7036” manufactured by Shin-Etsu Chemical Co., Ltd.), so as to form a conductive silicone rubber composition 25a.

Next, a metal shaft body S-0 having an outer diameter D of 14 mm and a length L of 350 mm was prepared. The metal shaft body S-0 was composed of a bar of stainless steel (SUS 22) electroless-nickel-plated. Then, the metal shaft body S-0 was washed using toluene, and was coated with a “primer No. 101A/B” (manufactured by Shin-Etsu Chemical Co., Ltd.). Then, the metal shaft body S-0 was calcined in a geer oven at a temperature of 185° C. for 30 minutes, and then cooled at a normal temperature for 30 minutes or more.

The conductive silicone rubber composition 25a and the metal shaft body S-0 having been prepared as described above were integrally extruded using an extrusion forming machine. Then, the metal shaft body S-0 with the silicone rubber composition 25a was put in an infrared oven, and was primarily calcined (i.e., hardened) while a temperature inside the oven is adjusted (i.e., a vulcanization temperature is adjusted). As a result, an original form of the sponge roller 25 having cells of predetermined diameters is formed.

Then, the original form of the sponge roller 25 was secondarily calcined in the geer oven at a temperature of 200° C. for 7 hours, and was left at the normal temperature for 1 hour more so as to obtain stable condition. Then, an outer circumference of the sponge roller was polished using a cylindrical grinding machine, so as to obtain the sponge roller S-1 of a predetermined size. The Asker hardness of the sponge roller S-1 was measured using Asker rubber hardness tester type F (Kobunshi Keiki Co., Ltd.), and was measured at a center position of the sponge roller S-1. On measurement, a surface of a terminal of the hardness tester was pressed against the surface of the sponge roller S-1 in parallel to the surface of the sponge roller S-1. As a result of measurement, the Asker hardness of the sponge roller S-1 was 52 Hs.

The sponge roller S-2 was obtained by primarily calcining the metal shaft body S-0 with the silicone rubber composition 25a in the geer oven at a temperature of 185° C. for 25 minutes, cooling the metal shaft body S-0 with the silicone rubber composition 25a at the normal temperature for 30 minutes or more, and performing subsequent processes in a similar manner to the sponge roller S-1. The Asker hardness of the sponge roller S-2 was 51 Hs.

The sponge roller S-3 was obtained by primarily calcining the metal shaft body S-0 with the silicone rubber composition 25a in the geer oven at a temperature of 180° C. for 30 minutes, cooling the metal shaft body S-0 with the silicone rubber composition 25a at the normal temperature for 30 minutes or more, and performing subsequent processes in a similar manner to the sponge roller S-1. The Asker hardness of the sponge roller S-3 was 50 Hs.

The sponge roller S-4 was obtained by primarily calcining the metal shaft body S-0 with the silicone rubber composition 25a in the geer oven at a temperature of 180° C. for 25 minutes, cooling the metal shaft body S-0 with the silicone rubber composition 25a at the normal temperature for 30 minutes or more, and performing subsequent processes in a similar manner to the sponge roller S-1. The Asker hardness of the sponge roller S-4 was 49 Hs.

The sponge roller S-5 was obtained by primarily calcining the metal shaft body S-0 with the silicone rubber composition 25a in the geer oven at a temperature of 175° C. for 30 minutes, cooling the metal shaft body S-0 with the silicone rubber composition 25a at the normal temperature for 30 minutes or more, and performing subsequent processes in a similar manner to the sponge roller S-1. The Asker hardness of the sponge roller S-5 was 48 Hs.

The sponge roller S-6 was obtained by primarily calcining the metal shaft body S-0 with the silicone rubber composition 25a in the geer oven at a temperature of 175° C. for 25 minutes, cooling the metal shaft body S-0 with the silicone rubber composition 25a at the normal temperature for 30 minutes or more, and performing subsequent processes in a similar manner to the sponge roller S-1. The Asker hardness of the sponge roller S-6 was 47 Hs.

A test was performed using the sponge rollers S-1 through S-6.

In this regard, the sponge roller 25 having the Asker hardness higher than 52 Hs was not used in the test. The reasons are as follows. A nip “N” (FIG. 7A) is formed between the developing roller 23 and the sponge roller 25 both having cylindrical shapes, and there is a difference in nip pressure between a center and at both ends in the axial direction of rollers. When the sponge roller 25 has a low hardness, the difference in nip pressure is easily absorbed. However, when the sponge roller has a high hardness, the difference in nip pressure can not be absorbed, and therefore a smear or an irregularity in density (in the axial direction of the rollers) may occur. Moreover, if the sponge roller 25 has high hardness, a large torque (substantially proportional to a product of a nip width and hardness) is required for rotating the sponge roller 25. For these reasons, the sponge roller 25 having the Asker hardness higher than 52 Hs was not used in the test.

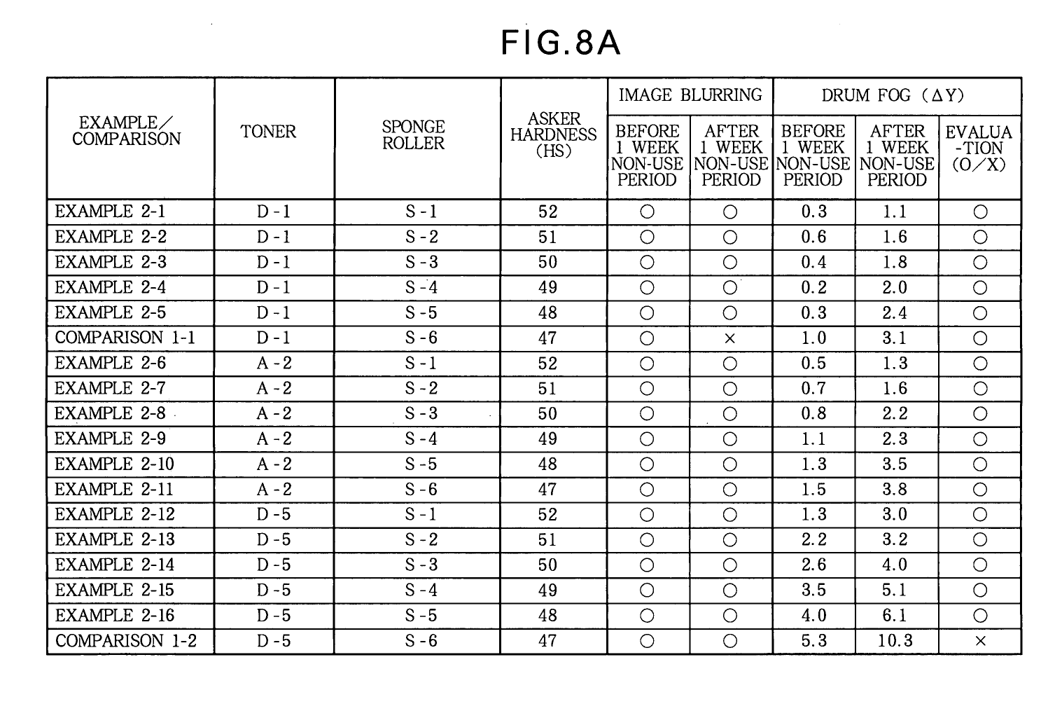

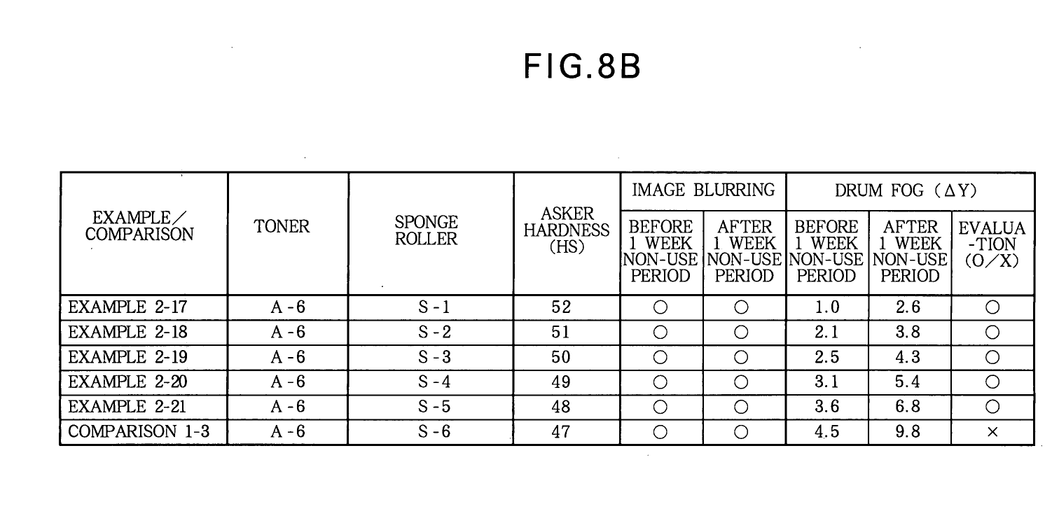

FIGS. 8A and 8B show the toners used for the test, the Asker hardness of the sponge rollers S-1 through S-6, the evaluation results of the image blurring and the drum fog.

As shown in FIGS. 8A and 8B, when the Asker hardness of the sponge roller 25 was higher than or equal to 48 Hs, the drum fog was enhanced even under high temperature and high humidity environment. By the combination of the toner T manufactured as described in the first embodiment and the sponge roller 25 having the Asker hardness higher than or equal to 48 Hs, the image blurring and the drum fog under high temperature and high humidity environment can be suppressed (i.e., excellent printing results were obtained) even after the non-use period of 1 week.

As a result, according to the second embodiment, the sponge roller 25 whose Asker hardness is higher than or equal to 48 Hs is used in combination with the toner T prepared in such a manner that the adding amount of the external additives is in a range from 1.5 to 3.0 weight parts, the mean volume diameter of the toner is in a range from 6.5 to 8.0 μm, and the surface roughness Rzjis of the toner measured using the scanning probe microscope is in a range from 75.3 to 236.9 nm. Therefore, the image blurring and drum fog under high temperature and high humidity environment can be suppressed even after a long period of non-use (for example, 1 week).

In the above described embodiments, the printer has been described as an example of the image forming apparatus, but the present invention is also applicable to, for example, a MPF (Multi Function Peripheral), a facsimile machine, a copier and the like.

While the preferred embodiments of the present invention have been illustrated in detail, it should be apparent that modifications and improvements may be made to the invention without departing from the spirit and scope of the invention as described in the following claims.

What is claimed is:

1. A developer comprising:
a toner containing toner mother particles and external additives added to said toner mother particles, said toner mother particles containing at least a resin and a coloring agent,
wherein 1.5 to 3.0 weight parts of said external additives are added to 100 weight parts of said toner mother particles, and
wherein said toner has a mean volume diameter in a range from 6.5 to 8.0 μm, and a surface roughness Rzjis in a range from 75.3 to 236.9 nm as measured using a scanning probe microscope.

2. The developer according to claim 1, wherein said external additives are composed of silica.

3. The developer according to claim 1, wherein said developer is a single-component developer.

4. The developer according to claim 1, wherein said toner is a spherically-shaped toner.

5. The developer according to claim 1, wherein said toner has a mean circularity greater than or equal to 0.97.

6. The developer according to claim 1, wherein said toner is manufactured by suspension polymerization method.

7. A developer storing body comprising:
a developer storing portion storing a developer,
said developer comprising:
a toner containing toner mother particles and external additives added to said toner mother particles, said toner mother particles containing at least a resin and a coloring agent,
wherein 1.5 to 3.0 weight parts of said external additives are added to 100 weight parts of said toner mother particles, and
wherein said toner has a mean volume diameter in a range from 6.5 to 8.0 μm, and a surface roughness Rzjis in a range from 75.3 to 236.9 nm as measured using a scanning probe microscope.

8. The developer storing body according to claim 7, wherein an agitating member is provided in said developer storing portion.

9. The developer storing body according to claim 7, wherein said developer storing portion leads to outside via an opening, and said opening is opened and closed by an opening-and-closing member.

10. A developing device comprising:
a developer storing body storing a developer;
a developer bearing body that bears said developer supplied from said developer storing body, and
an image bearing body to which said developer is supplied by said developer bearing body,
wherein said developer comprising:
a toner containing toner mother particles and external additives added to said toner mother particles, said toner mother particles containing at least a resin and a coloring agent,
wherein 1.5 to 3.0 weight parts of said external additives are added to 100 weight parts of said toner mother particles, and
wherein said toner has a mean volume diameter in a range from 6.5 to 8.0 μm, and a surface roughness Rzjis in a range from 75.3 to 236.9 nm as measured using a scanning probe microscope.

11. The developing device according to claim 10, further comprising a main body in which said developer bearing body and said image bearing body are provided, and
wherein said developer storing body is detachably mounted to said main body.

12. The developing device according to claim 10, further comprising a developer supplying body that supplies said developer from said developer storing body to said developer bearing body.

13. The developing device according to claim 12, wherein said developer supplying body has an Asker hardness higher than or equal to 48 Hs.

14. An image forming apparatus comprising:
a developing device that stores a developer, and forms a developer image using said developer;
a transferring unit that transfers said developer image formed by said developing device to a recording medium, and
a fixing unit that fixes said developer image to said recording medium,
wherein said developer comprises:
a toner containing toner mother particles and external additives added to said toner mother particles, said toner mother particles containing at least a resin and a coloring agent,
wherein 1.5 to 3.0 weight parts of said external additives are added to 100 weight parts of said toner mother particles, and
wherein said toner has a mean volume diameter in a range from 6.5 to 8.0 μm, and a surface roughness Rzjis in a range from 75.3 to 236.9 nm as measured using a scanning probe microscope.

15. The image forming apparatus according to claim 14, wherein said developing device comprises:
a developer storing body that stores said developer;
a developer bearing body that bears said developer;
a developer supplying body that supplies said developer from said developer storing body to said developer bearing body, and
an image bearing body to which said developer is supplied by said developer bearing body.

16. The image forming apparatus according to claim 15, wherein said developer supplying body has an Asker hardness higher than or equal to 48 Hs.

17. The image forming apparatus according to claim 14, wherein said developing device is detachably mounted to a main body of said image forming apparatus.

18. The image forming apparatus according to claim 14, wherein said developer storing body is detachably mounted to a main body of said image forming apparatus.
